(19) United States
(12) Patent Application Publication
(10) Pub. No.: US 2004/0067415 A1
(43) Pub. Date: Apr. 8, 2004

(54) Sectional battery structure

(76) Inventor: Ming-Chien Lai, Taoyuan (TW)

Correspondence Address: TROXELL LAW OFFICE PLLC, SUITE 1404, 5205 LEESBURG PIKE, FALLS CHURCH, VA, 22041, US

(21) Appl. No.: 10/294,640

(22) Filed: Nov. 15, 2002

(30) Foreign Application Priority Data
Oct. 3, 2002 (TW) 091215689

(51) Int. Cl. H01M 2/02; H01M 2/30

(52) U.S. Cl. 429/176; 429/178; 429/179; 429/7

(57) ABSTRACT

The present invention herein relates to a sectional battery structure for composing battery unit comprises a battery, a battery outer shell, two contact cubes a plurality of terminals and circuit device. The battery is a cylinder having a hollow part of positive electrode. The battery outer shell have slot and corresponding protrusive part to match hollow part, thus putting the wrong direction of battery to disconnect battery outer shell thereof. Two contact cubes have a screw hole on each side; and a plurality of terminals has screw on both ends. The circuit device has protective circuit and smart electricity meter circuit. The sectional battery is selected from the group consisting of series connection, parallel connection, and series-parallel connection.

### REFERENCE CITED

U.S. Pat. No.: 6,309,777

### FIELD OF THE INVENTION

The present invention relates to a sectional battery structure, particularly to sectional battery in corresponding application of electric appliance. Therefore, this invention can be employed an easy connective process with battery unit for sectional battery.

### BACKGROUND OF THE INVENTION

In general, the ways of providing electricity are alternating current and direct current. The alternating current comes from indoor fixed socket, and direct current comes from uniform cylindrical battery. Although the indoor fixed socket can provide enough electricity, indoor fixed socket cannot move. In the contrast, battery is portable, but cannot provide long-lasting electricity.

Moreover, due to the continuous development of technology and more and more new type of electric appliance such as laptop computer, cordless telephone, PDA, and so on, requirement of electricity and long waiting time are always increasing. Thus, Nickel-Metal Hydride battery is not suitable for using. The most direct and easy solution for solving the problem of Nickel-Metal Hydride battery is to use a lithium-ion battery to satisfy requirement of electricity and long waiting time for electric appliance. However, if the negative electrode and positive electrode of lithium-ion battery are put in the wrong direction, the battery operating stability will be affected. Thus, this kind of lithium-ion battery is more dangerous than the Nickel-Metal Hydride battery.

In order to improve this disadvantage, Tomoyuki Ohta et al., U.S. Pat. No.: 6,309,777, Explosion-resistant large capacitive lithium ion secondary battery, that discloses an active material free part of a positive electrode is coated with an over-coat material, wherein the over-coat material has at least one of the following properties: suppression of heat transfer from the second part of the electrode to the separator; reduction of a heat transfer rate from the second part of the electrode to the separator; prevention of transfer of excess heat from the second part of the electrode to the separator; electrical isolation of the second part of the electrode from the separator; prevention of charges generated in the first active material from becoming concentrated in the second part of the electrode and discharged from the second part; and prevention of the separator from being melted by a current discharge from or into the second part of the electrode through the separator until the current discharge is shut down by a fuse function of the separator. However the electricity cannot increase for a fixed specification.

In view of the various disadvantages of conventional battery, the present invention addresses the disadvantages by researching solutions for them which, following continuous research and improvements, culminated in the structure easy and convenient for sectional battery structure of the invention herein, a structure capable of eliminating the numerous drawbacks of the conventional technology.

### OBJECT OF THIS INVENTION

Due to the continuous development of industry, requirement of electricity and long waiting time are always important. Thus, the improvement of battery structure is to be of great urgency.

Therefore, the main object of the present invention is to provide high safety for sectional battery structure.

Another object of the present invention is to provide a sectional battery structure for composing the battery unit becoming convenient function.

### SUMMARY OF THE INVENTION

Specifically, the present invention of a sectional battery structure for composing battery unit comprises a battery, a battery outer shell, two contact cubes, a plurality of terminals and circuit device. The battery is a cylinder having a hollow part of positive electrode. The battery outer shell comprises two shell bodies, wherein one side of the shell body is connected with connecting page, the other side has connecting part, the adjacent side of said connecting part has screw hole, and the inside battery outer shell has slot and corresponding protrusive part to match hollow part, thus putting the wrong direction of battery to disconnect battery outer shell thereof. Two contact cubes have a screw hole on each side; and a plurality of terminals has screw on both ends. The circuit device forms in adjustable shell body, comprising a circuit board, a input port and a output port, wherein the circuit board has protective circuit and smart electricity meter circuit, and extending electric wires for input ports and output ports thereof and form on said shell body. The sectional battery is selected from the group consisting of series connection, parallel connection, and series-parallel connection.

### BRIEF DESCRIPTION OF THE DRAWINGS

The present invention will be better understood from the following detailed description of preferred embodiments of the invention, taken in conjunction with the accompanying drawings, in which

FIG. 1 is a perspective diagram of battery unit in accordance with the present invention;

FIG. 1a is a perspective diagram of components part in accordance with the present invention;

FIG. 2 is a perspective diagram of terminals and plug in accordance with the embodiment of the present invention.

FIG. 3 is a perspective diagram of the flexible terminal in accordance with the embodiment of the present invention;

FIG. 4 is a perspective diagram of first embodiment in accordance with the present invention;

FIG. 4a is a circuit diagram in accordance with FIG. 4;

FIG. 5 is a perspective diagram of second embodiment in accordance with the present invention;

FIG. 5a is a circuit diagram in accordance with FIG. 5; and

FIG. 6 is a perspective diagram of third embodiment in accordance with the present invention.

### DESCRIPTION OF THE PREFERRED EMBODIMENTS

According to the disadvantages of conventional battery as described above, the present invention provides an improvement solution for that. Embodiments of this invention will be described in detail with reference to attached drawings.

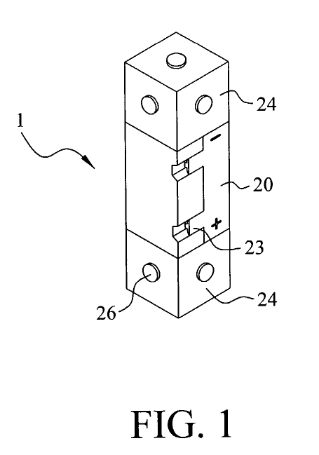

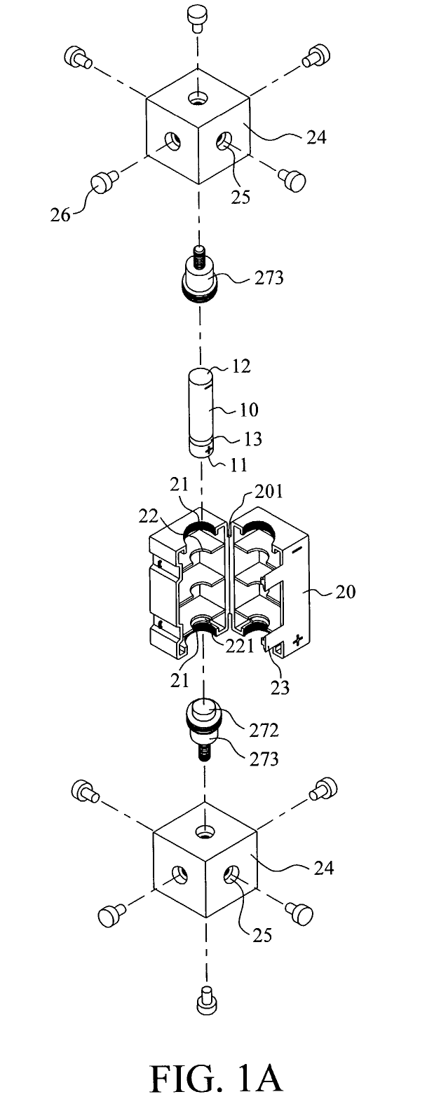

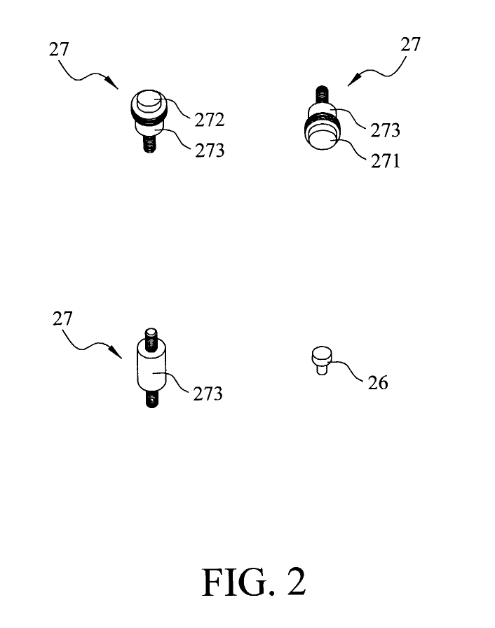

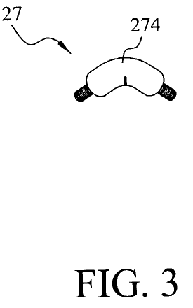

Please referring to FIG. 1, FIG. 1a, FIG. 2 and FIG. 3 of a battery unit with the present invention, it provides a battery 10, a battery outer shell 20, two contact cubes 24, and a plurality of terminals 27, wherein said battery 10 having hollow part 13 of positive electrode 12 is a cylindrical battery with one end being a negative electrode 11 and the other end being a positive electrode 12 (such as: lithium-ion battery 18650); said battery outer shell 20 is a plastic injection molded article comprising two shell bodies, wherein one side of said shell body is connected with connecting page 201, and the other side has connecting part 23, the adjacent side of said connecting part 23 has screw hole 21, the inside said battery outer shell 20 has ribs with slot 22 in equidistance for battery 10, and one of slot 22 has protrusive part 221. Besides, the surface of shell body marks positive and negative electrode separately for identify position of battery electrode; said two contact cubes 24 have a screw hole 25 with plug 26 on each side; and said a plurality of terminals 27 have screw on both ends to screw with contact cube 24 and battery outer shell 20 comprising negative electrode terminal 272, positive electrode terminal 271, fixed terminal 273 and flexible terminal 274, wherein said positive electrode terminal 272 and negative electrode terminal 271 have elasticity of demand to connect the battery outer shell 20; said fix terminal 273 consists of 180 degree, 90 degree, 60 degree, 45 degree, and 30 degree, and said flexible terminal 274 is made of flexible material and is adjustable for angle of demand. Said battery outer shell further comprises a sleeve for battery 10 putting inside directly.

The present invention overcomes a safety problem with shell body 31. Thus a circuit device 30 forms in adjustable shell body 31, comprising a circuit board 32, a input port 33 and a output port 34, wherein said circuit board 32 has protective circuit and smart electricity meter circuit, and extending electric wires for input ports 33 and output ports 34 thereof and form on said shell body 31 marking positive electrode and negative electrode to avoiding wrong connection. However, the protective circuit on said circuit board 32 further comprises smart battery system.

Furthermore refer to FIG. 1, a battery unit 1 form with said battery 10 into said battery outer shell 20 to match said hollow part 13 corresponding to protrusive part 221 of said slot 22 for connection of the said battery outer shell 20 by connecting part 23 otherwise disconnection of the said battery outer shell 20 thereof and so-called first protection. Moreover positive electrode terminal 272 screw with screw hole 25 of contact cube 24 removing plug 26 and screw hole 21 of battery outer shell 20 marking positive electrode (using negative electrode terminal 271 is similar to positive electrode terminal 272), The negative electrode terminal 271 and positive electrode terminal 272 have elasticity of demand to connect the battery outer shell 20. Thus, a battery unit 1 may increase operational characteristics and it also may do sectional battery for series connection, parallel connection, or series-parallel connection directly, which does not only possess a better practicality, neither only a conception based on familiarity of utilization, it is non-obviousness.

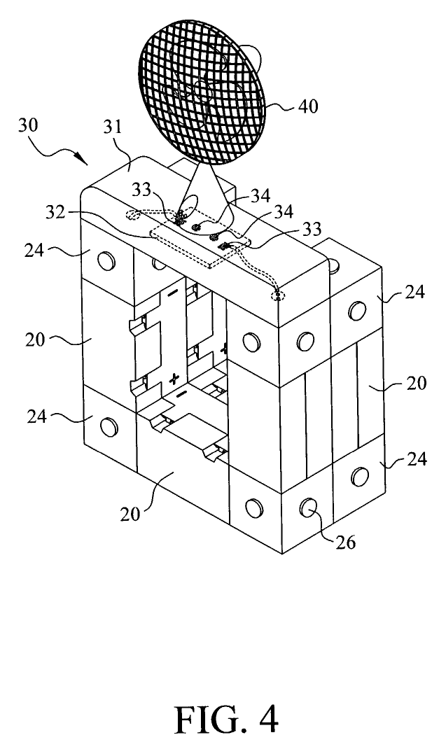

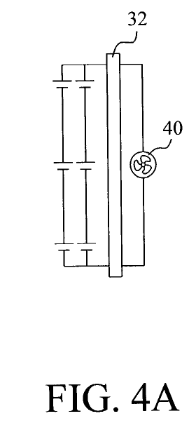

Next, please referring to FIG. 4 provides a sectional battery of series-parallel connection in accordance with first embodiment of the present invention, that shows fix terminal 273 screw with screw hole 25 of positive electrode contact cube 24 removing plug 26 for first battery unit 1 and screw hole 25 of negative electrode contact cube 24 removing plug 26 for second battery unit 1, using another fix terminal 273 screw with screw hole 25 of positive electrode contact cube 24 removing plug 26 for second battery unit 1 and screw hole 25 of negative electrode contact cube 24 removing plug 26 for third battery unit 1, and then first battery unit 1, second battery unit 1 and third battery unit 1 connect with series connection in η shape. Connection two series connections with series—parallel connection use two fix terminals 273 to screw with two contact cube 24 of positive electrode and negative electrode for head and tail of series connections, and then use another two fix terminals 273 to screw with circuit device 30 on one of series connections of battery unit 1, output port 34 of circuit device 30 to connect with a electrical appliance (such as: fan 40), thus sectional battery become the suitable base for electrical appliance. Please referring to FIG. 4a showing a circuit diagram in accordance with FIG. 4, it provide protect circuit and smart electricity metering circuit in circuit board 32 of interior circuit device 30 for another protection of sectional battery and convenience to inform the user how much electricity of sectional battery, and enough electricity for fan 40.

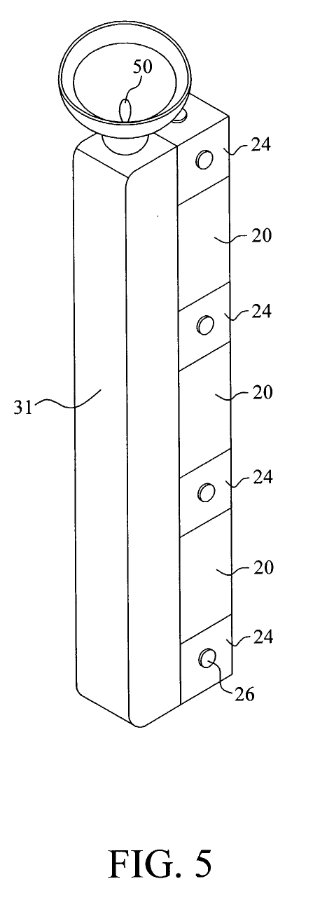

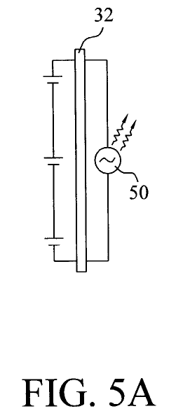

Please referring to FIG. 5 to FIG. 5a illustrated second embodiment of the present invention, that shows series connection of three battery units 1 by head of battery unit 1 connecting with tail of battery unit 1 via two fix terminals 273, and screwing with contact cube 24 of sectional battery and elongation shell body 31 of circuit device 30 to fit length of sectional battery, then output port 34 of circuit device 30 connect with a lamp 50 for sectional battery becoming a holding body of a flashlight.

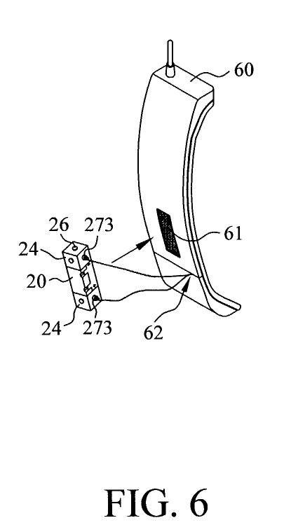

Furthermore referring to FIG. 6 illustrated third preferred embodiment of the present invention, that shows cordless telephone 60 using battery unit 1 with fastener 61 to connect battery outer shell 20 by placing power line 62 of cordless telephone 60 into fix terminal 273 of contact cube 24 of battery unit 1. Moreover, the fix terminal 273 can be changed into flexible terminal 274 for angle of demand.

In conclusion, the sectional battery structure according to present invention has the following advantages:

1. The battery and slot of battery outer shell according to present invention have hollow part and protrusive part to match each other, thus putting the wrong direction to disconnect battery outer shell thereof and so-called first protection of sectional battery.

2. Each side of the contact cube has screw hole with plug, it screw with battery unit into any direction.

3. In present invention, since surface of battery outer shell mark clearly for direction of battery electrode, it is able to connect negative electrode terminal and positive electrode terminal easily.

4. The present invention provides a sectional battery not only to satisfy user of demand, but also after connection of battery unit to be the base or handle of the electrical appliance.

5. In the present invention comprise fix terminal consists of angle in common use and the flexible terminal which is adjustable for angle of demand. It is useful.

6. The present invention has circuit device forming in adjustable shell body, depending on the shape of sectional battery to extend or shorten shell body shell body make connection thereof and so-called second protection of sectional battery.

The foregoing description of the preferred embodiments of the present invention has been provided for the purpose of illustration and description. It is not intended to be exhaustive or to limit the invention to the precise forms. Obviously many modification, variation and simple derivation will now become apparent to the practitioner skilled in the art.

To sum up, the sectional battery structure according to the present invention is easily and conveniently combined. In contract to present battery structure, it is innovation, and obvious to see the function. It is intended that the scope of the invention be defined by the following claims and their equivalents.

What is claimed is:

1. A sectional battery structure for composing the battery unit, comprising:
a battery;
a battery outer shell comprising two shell bodies, wherein one side of the shell body is connected with each other, and the other side has connecting part, the adjacent side of said connecting part has screw hole, and the inside said battery outer shell having slots;
two contact cubes having a screw hole on each side; and
a plurality of terminals having screw on both ends.

2. The sectional battery structure according to claim 1, wherein
said battery has hollow part on the surface.

3. The sectional battery structure according to claim 1, wherein
said battery outer shell fit the shape of the battery to slot and corresponding protrusive part.

4. The sectional battery structure according to claim 1, wherein
said contact cube has plug for each side screw hole.

5. The sectional battery structure according to claim 1, wherein
said terminal is selected from the group consisting of positive electrode terminal, negative electrode terminal, fix terminal and flexible terminal.

6. The sectional battery structure according to claim 5, wherein
said positive electrode terminal and said negative electrode terminal have elasticity of demand to connect the battery outer shell.

7. The sectional battery structure according to claim 5, wherein
said fix terminal is selected from the group consisting of 180 degree, 90 degree, 60 degree, 45 degree, and 30 degree.

8. The sectional battery structure according to claim 5, wherein
said flexible terminal is made of flexible material and adjustable for angle of demand.

9. The sectional battery structure according to claim 1, wherein
said sectional battery connect a circuit device.

10. The sectional battery structure according to claim 9, wherein
said circuit device forms in adjustable shell body, comprising a circuit board, a input port and a output port, wherein said circuit board has protective circuit and smart electricity meter circuit, and extending electric wires for input ports and output ports thereof and form on said shell body.

11. The sectional battery structure according to claim 1, wherein
said sectional battery is selected from the group consisting of series connection, parallel connection, and series-parallel connection.

12. The sectional battery structure according to claim 1, wherein
said battery outer shell is a sleeve for battery.
